(19) United States
(12) Patent Application Publication
(10) Pub. No.: US 2017/0217100 A1
(43) Pub. Date: Aug. 3, 2017

(54) Method and Apparatus for Fabricating an Object

(71) Applicant: Laing O'Rourke Australia Pty Limited, North Sydney, New South Wales (AU)

(72) Inventor: James Bruce GARDINER, Chippendale (AU)

(21) Appl. No.: 15/127,923

(22) PCT Filed: Mar. 23, 2015
(86) PCT No.: PCT/AU2015/050126

§ 371 Date: Sep. 21, 2016

(30) Foreign Application Priority Data
Mar. 21, 2014 (AU) 2014901001

(51) Int. Cl. B29C 67/00; B33Y 30/00; B33Y 50/02; B33Y 10/00

(52) U.S. Cl. CPC B29C 67/0088; B29C 67/0066; B33Y 10/00; B33Y 30/00; B33Y 50/02

(57) ABSTRACT

A method for fabricating an object with a computer-controlled apparatus and the apparatus therefor. The apparatus comprises a reservoir containing liquid, curable material, means to selectively solidify the curable material and a platform for supporting cured material which is movable relative to the reservoir and rotatable about at least one axis. The method involves the steps of selectively solidifying portions of the curable material, whereby at least one portion abuts the platform, moving the platform, thereby repositioning the solidified portions supported thereon, and rotating the platform, thereby reorientating the solidified portions supported thereon.

### TECHNICAL FIELD

The present invention relates generally to fabricating objects and in particular, relates to fabricating an object from a substantially liquid, curable material with a computer-controlled apparatus.

### BACKGROUND TO THE INVENTION

Additive manufacturing, commonly known as 3D printing, is a manufacturing technique used to fabricate objects, such as prototype product components. An additive manufacturing process typically involves preparing a digital 3D model of the object with computer software, deriving computer instructions from the 3D model which define a series of parallel, planar cross-sections of the object and providing a 3D printer with the computer instructions, which guide the 3D printer to fabricate successive layers of material corresponding with the cross-sections, one on top of another, until all object layers are fabricated.

Many different types of additive manufacturing processes exist, the most common being stereolithography (SLA), selective laser sintering (SLS) and fused filament fabrication (FFF). Stereolithography involves tracing the cross-sections of the object on a top surface of a vat of liquid curable photopolymer with a light source (typically being an ultraviolet laser or lamp), causing the liquid photopolymer to cure to a consistent depth where the light source is focused on the top surface. The cured photopolymer forms a layer of the object and is supported on a platform arranged in the vat. After the layer is fabricated, the platform is lowered into the vat by the thickness of the layer, and a second cross-section is traced, forming a second layer which bonds to the first layer. This process is repeated, with successive layers being fabricated and the platform progressively lowering into the vat until the object is fabricated.

Stereolithography offers a number of advantages over traditional manufacturing techniques, such as injection moulding. However, stereolithography, also suffers from a number of drawbacks. For example, as objects fabricated using stereolithography are formed from solidifying a plurality of parallel layers in a stack, the geometry of objects able to be fabricated is limited to being formed from flat, planar layers. Where the outer surfaces of the object are curved, this inherently forms steps between layers, degrading the smoothness of the outer surfaces.

Accordingly, it would be useful to provide an alternative method or apparatus for selectively solidifying liquid, curable material which allows an object to be fabricated from non-planar layers or which reduces or eliminates steps between layers.

### SUMMARY OF THE INVENTION

According to one aspect of the present invention there is provided a method for fabricating an object using a computer-controlled apparatus, the apparatus having a reservoir at least partially filled with a substantially liquid, curable material, an activation head movable relative to the reservoir, and a platform movable relative to the reservoir and rotatable about at least one axis, the method comprising the steps of: receiving, by the apparatus, computer instructions relating to the object geometry; moving and selectively operating the activation head, thereby selectively solidifying portions of the curable material in specific locations corresponding with the object geometry, at least some of the solidified portions abutting the platform; moving the platform, thereby repositioning the solidified portions supported thereon; and rotating the platform, thereby reorientating the solidified portions supported thereon.

According to another aspect of the invention, there is provided a computer-controlled apparatus for fabricating an object, the apparatus comprising: a reservoir at least partially filled with a substantially liquid, curable material; an activation head for solidifying the curable material, the activation head being movable relative to the reservoir; a platform movable relative to the reservoir and rotatable about at least one axis; and a controller, configured to move the activation head and platform responsive to computer instructions relating to the object geometry; wherein the controller moves and selectively operates the activation head to solidify portions of the curable material in specific locations corresponding with the object geometry, at least some of the solidified portions abutting the platform; and the controller moves and rotates the platform, thereby repositioning the solidified portions supported thereon.

Other aspects are disclosed.

### BRIEF DESCRIPTION OF THE DRAWINGS

Preferred embodiments of the invention will now be described, by way of example only, with reference to the accompanying drawings in which:

FIGS. 1A to 1D are cross-section views of an apparatus fabricating an object;

FIG. 2 is a cross-section view of an alternative apparatus fabricating an alternative object;

FIG. 3 is a cross-section view of a further alternative apparatus fabricating a further alternative object;

FIG. 4 is a cross-section view of another alternative apparatus fabricating another alternative object;

FIG. 5A is a perspective view of an alternative aspect of the apparatus shown in FIGS. 1A to 1D fabricating an alternative object;

FIG. 5B is a diagram demonstrating variable width of solidified curable material fabricated with the apparatus shown in FIG. 5A;

FIG. 6 is a perspective view of the apparatus shown in FIGS. 1A to 1D fabricating an alternative object comprising a prefabricated frame;

FIG. 7 is a perspective view of a fixing plate; and

FIGS. 8A to 8E are cross-section views of various stages of fabricating a further alternative object on the fixing plate shown in FIG. 7.

### DETAILED DESCRIPTION OF PREFERRED EMBODIMENTS

The present disclosure relates to a method and apparatus for fabricating an object. The apparatus comprises a reservoir at least partially filled with a substantially liquid, curable material, an activation head for solidifying the curable material, the activation head being movable relative to the reservoir, a platform movable relative to the reservoir and rotatable about at least one axis, and a controller, configured to move the activation head and platform responsive to computer instructions relating to the object geometry. The method involves the steps of receiving, by the apparatus, computer instructions relating to the object geometry, moving and selectively operating the activation head, thereby selectively solidifying portions of the curable material in specific locations corresponding with the object geometry, whereby at least one portion abuts the platform, moving the platform, thereby repositioning the solidified portions supported thereon, and rotating the platform, thereby reorientating the solidified portions supported thereon.

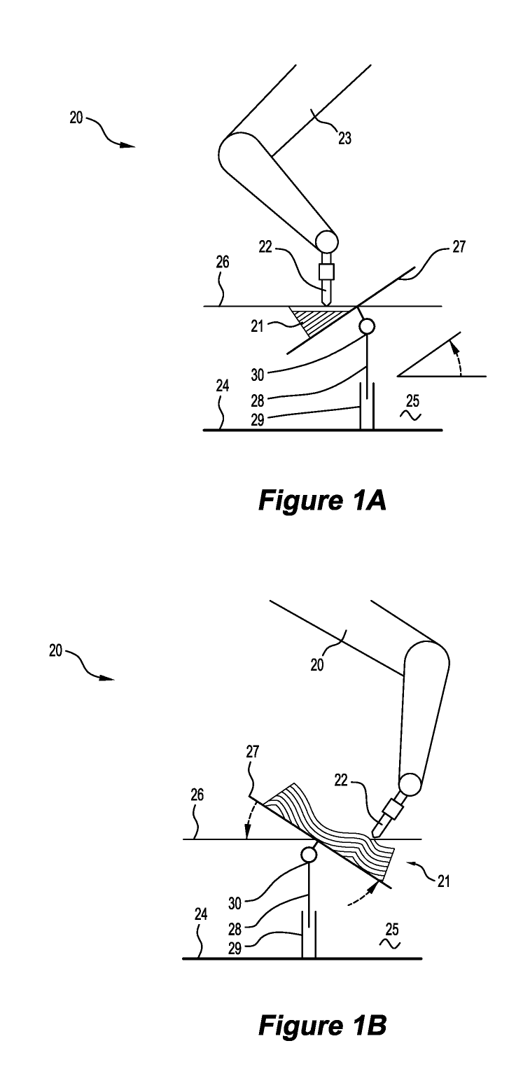

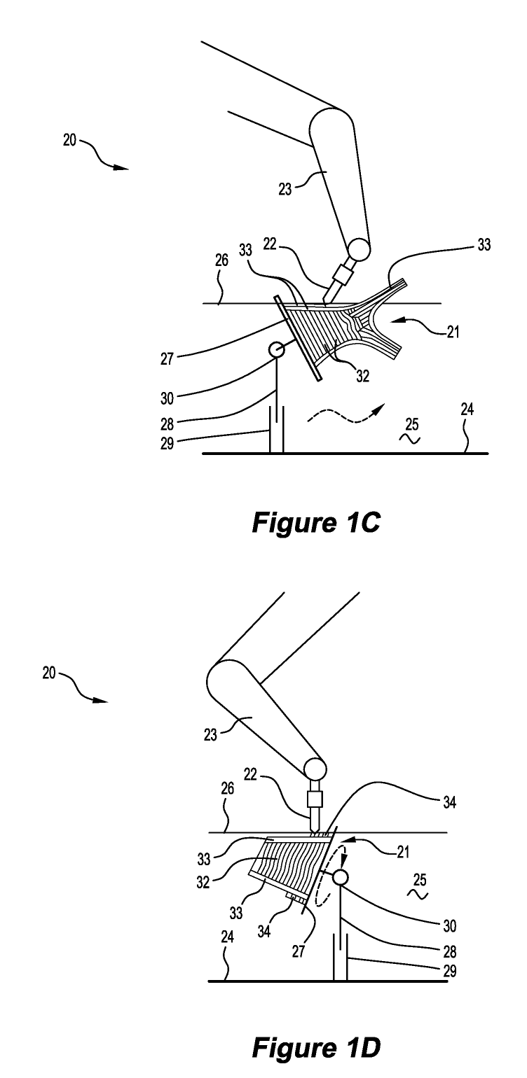

FIGS. 1A-1D show a computer-controlled apparatus 20 in various stages of fabricating an object 21. The apparatus 20 has an activation head 22 connected to a first robotic arm 23 arranged above a reservoir 24 at least partially filled with a substantially liquid, curable material 25 defining a top surface 26. The activation head 22 is in communication with an energy source (not shown), such as an ultraviolet laser or lamp, which is suitable for curing the curable material 25. When operated, the activation head 22 exposes and may also focus the energy source on the reservoir 24. A platform 27 having at least one planar support surface for supporting the object 20 is connected to a second robotic arm 28 disposed in the reservoir 24. Each robotic arm 23, 28 has a number of sections rotatably and/or slidably connected to each other to allow movement of the activation head 22 and platform 27 in all three dimensions. The activation head 22 and platform 27 are movable relative to the top surface 26 and/or each other by a controller (not shown), responsive to computer instructions relating to the object 21 geometry provided to the apparatus 20. The computer instructions are typically derived from a digital three-dimensional (3D) model of the object 21 and define the object 20 geometry.

The object 21 is fabricated by the activation head 22 selectively solidifying portions of the curable material 25 in specific locations corresponding with the object 21 geometry. This typically involves moving and selectively operating the activation head 22 proximally above the top surface 26 to selectively solidify portions of the curable material 25 at the top surface 26. The solidified portions are supported on the platform 27 and moved relative to the top surface 26 by moving the platform 27. The solidified portions have a predetermined depth and are typically formed as beads. When the object 21 is fabricated in layers, each layer generally comprises one or more beads. Alternatively, the activation head 22 includes a projector (not shown) and projects a cross-section of the object 21 geometry onto the top surface 26, thereby fabricating an entire layer of the object 21 from a single projection.

During the fabrication process, the controller directs the second robotic arm 28 to adjust the orientation and position of the platform 27 relative to the top surface 26 and/or the activation head 22, thereby moving solidified portions of curable material 25 supported thereon. This may be by moving the platform 27 perpendicular to or laterally across the top surface 26 and/or rotating the platform 27 around at least one axis, and potentially around three axes. The second robotic arm 28 may comprise one or more telescopic sections 29 and rotatable joints 30 to allow linear and rotational movement of the platform 27.

Whilst the activation head 22 typically operates a short distance above the top surface 26 to solidify portions of the curable material 25 at the top surface 26, it will be appreciated that the activation head 22 may alternatively be submerged within the reservoir 24 and selectively operated to solidify portions of the curable material 25 therein. When this is performed, the activation head 22 may be adapted to form a layer of oxygen across an end thereof to prevent solidified material bonding to the activation head 22.

In an alternative embodiment (not shown) of the apparatus 20, the reservoir 24 has an energy permeable base (not shown), such as having a transparent portion which transmits lights, and the activation head 22 includes a projector (not shown) arranged under the base. The apparatus 20 is adapted to form a layer of oxygen across the base to prevent cured material adhering to the base. The platform 27 is suspended above the reservoir 24 by the robotic arm 28 and has a surface for receiving solidified portions of the curable material 25 arranged at least initially facing the base. In this embodiment, the apparatus 20 fabricates the object 21 by the projector projecting cross-sections of the object 21 geometry through the base, thereby solidifying a layer of curable first material 57 corresponding with each projected cross-section. A first layer of the object 21 adheres to the platform 27 and each subsequent layer adheres to one or more previous layers. The platform 27 is progressively withdrawn out of the reservoir 24 to move the fabricated layers away from the base, which may also involve rotating the platform about one or more axes, thereby rotating the fabricated layers relative to the base.

Referring to FIG. 1B, this shows the apparatus 20 fabricating the object 21 from curved, non-planar layers 31. These layers 31 are fabricated by simultaneously moving and rotating the platform 27 relative to the top surface 26 and operating the activation head 22, thereby forming undulating, non-planar beads of solidified curable material 25.

Referring to FIGS. 1C and 1D, these show the apparatus 20 fabricating the object 21 having cross-laminated layers 32, 33, where beads forming a first layer 32 are arranged at an angle relative to beads forming a second, adjacent layer 33. For example, first layers 32 are fabricated in a first orientation generally parallel to the platform 27, and second layers 33 are fabricated in a second orientation generally perpendicular to the first orientation and at least partially enclosing the first layers 32. The cross-lamination of the first and second layers in this way means that the bond region, which is typically weak, between the second layers 33 are arranged across the bond region, which is also typically weak, between the first layers 32. This forms a lattice-like structure where the layers 32, 33 are less likely to shear and separate when subjected to forces, which decreases the likelihood of the object 21 delaminating when subjected to particular loading cycles during use, or due to expansion or shrinkage.

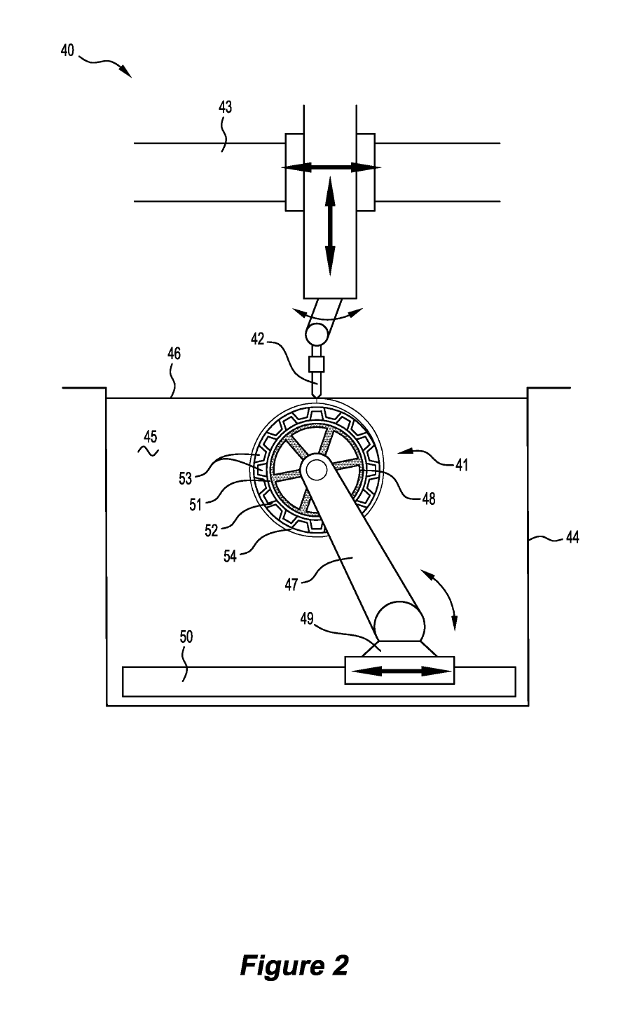

FIG. 2 shows an alternative apparatus 40 fabricating an alternative object 41. The apparatus 40 has an activation head 42 suspended from a gantry 43 above a reservoir 44 at least partially filled with liquid curable material 45 forming a top surface 46. The activation head 43 is movable in all three dimensions relative to the top surface 46, and rotatable about at least one axis. A robotic arm 47 having a generally cylindrical platform, configured as a spindle 48, rotatably connected thereto is disposed within the reservoir 44. The robotic arm 47 is attached to a carriage 49 which moves across one or more tracks 50 arranged in the reservoir, and pivots relative to the carriage 49, thereby moving the spindle 48 relative to the top surface 46 and activation head 42. The robotic arm 47 may include one or more telescopic sections (not shown) to move the spindle 48 towards and away from the top surface 46, and may also be rotatable relative to the carriage 49, thereby rotating the spindle 48 about an additional axis. The apparatus 40 has a controller (not shown) which controls the movement and rotation of the spindle 48 responsive to computer instructions derived from a digital 3D model of the object 41.

The object 41 is fabricated by the activation head 42 selectively solidifying portions of the curable material 45 at the top surface 46, as previously described. The object 41 is shown partially fabricated having three generally cylindrical layers; an inner layer 51 abutting the spindle 48, a mid-layer 52 defining a plurality of voids 53 and abutting the inner layer 51, and an outer layer 54 wrapped around the mid-layer 52. The voids 52 have been formed by moving the spindle 48 towards and away from the top surface 46 whilst also rotating the spindle 48 and operating the activation head 42.

The solidified portions 51, 52, 54 are supported by the spindle 48 and moved and rotated relative to the top surface 46 by the spindle 48. This allows generally cylindrical objects to be fabricated efficiently, as the spindle 48 axis can be arranged parallel to the top surface 46, as shown in FIG. 2, and the spindle 48 rotated therearound as the activation head 42 is operated, thereby solidifying curable material 45 to form a curved bead or curved layer. When the activation head 42 is maintained in the same position, this will form a ring-shaped bead, and when the activation head is moved along the spindle 48 axis, this will form a helical shaped bead. Optionally, the spindle 48 is rotatable about two or more axes, meaning that double-curved beads of solidified curable material 45 can be fabricated by rotating the spindle 48 about two axes and potentially also moving the spindle 48 relative to the top surface 46. Cross-laminated layers (not shown) can also be fabricated, by fabricating beads of solidified curable material 45 which extend along the length of the spindle 48 and across ring-shaped beads therebelow.

In a further aspect of the apparatus 40 (not shown), the apparatus 40 is adapted to insert fibres into the curable material 45 proximal to the activation head 42 prior to or during solidification of the curable material 45, such that the fibres are integrated into a bead of solidified curable material 45. Where an object fabricated by the apparatus 40 has outer layers wrapping around inner layers, such as outer layer 54 and mid-layer 52 of object 41, the fibres may be continuously inserted into the outer layer 54, forming continuous fibres which extend through the solidified bead to increase the strength of the layer 54.

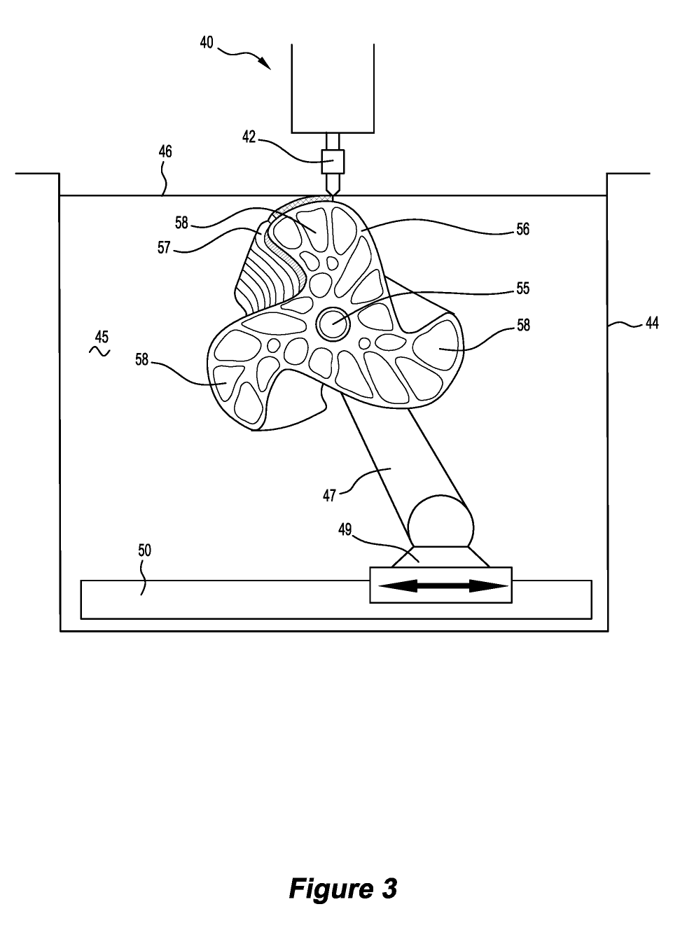

FIG. 3 shows a variation of the apparatus 40, where the cylindrical platform is configured as a shaft 55 to which a former 56 is secured. The former 56 is a pre-fabricated structure, potentially by using an alternative additive manufacturing process, and has complex, non-standard geometry, such as double curved spoke portions 58. The former 56 is used as a support structure for fabricating an alternative object 57 on, whereby the former 56 is moved and rotated by the apparatus 40 during the fabrication process, allowing solidified curable material 45 to be supported thereon. The former 56 may remain as an integral part of the finished object 57, or may be removed, exposing a cavity in the object 57. For example, where the former 56 is formed from a meltable material such as a wax compound, the former 56 may be heated and melted after the object 57 is fabricated.

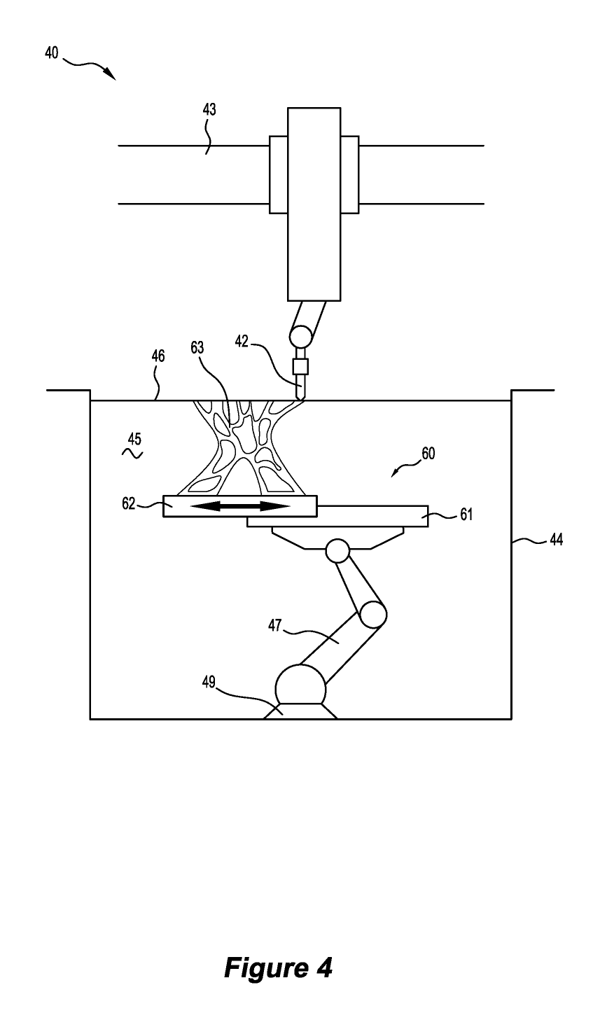

FIG. 4 shows a further variation of the apparatus 40, where the platform is configured as an assembly 60, comprising a base 61 rotatably connected to the robotic arm 47, and a top section 62 slidably connected to the base 61. The apparatus 40 is shown fabricating a further alternative object 63, where the top section 62 is displaced relative to the base 61 and parallel to the top surface 46. Sliding the top section 62 in this way may increase the efficiency of fabricating some portions of the object 63, as the top section 62 can be rapidly moved across the top surface 46 as the activation head 42 is operated.

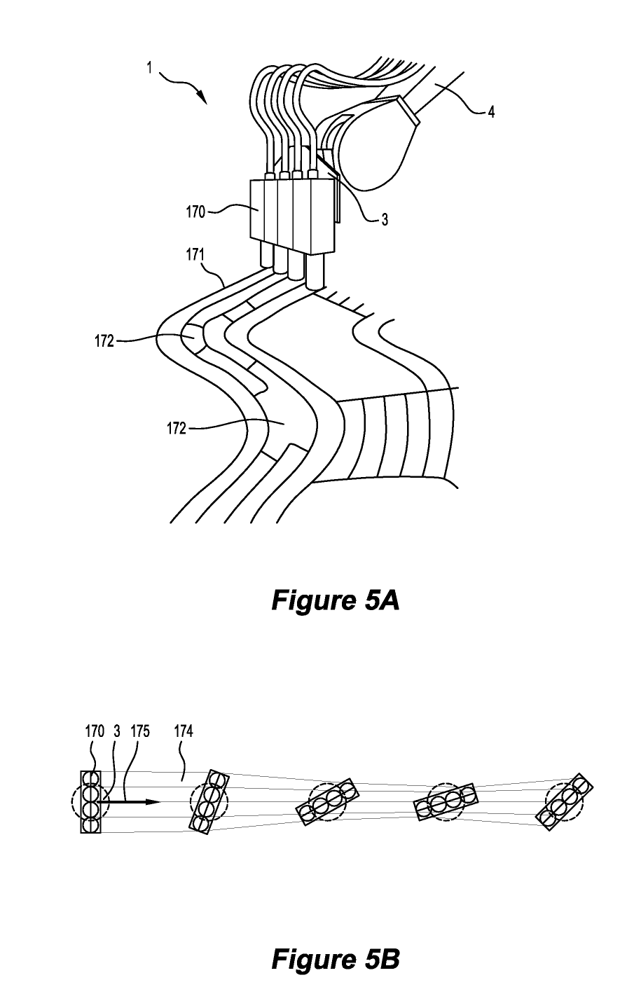

FIG. 5A shows a further alternative aspect of the apparatus 20, where the activation head 22 has a plurality of nozzles 170 in communication with the energy source and adapted to selectively focus the energy source on the top surface 26, thereby solidifying portions 171 of the curable material 25. The nozzles 170 are arranged in a linear array and rotatable around an axis arranged by the robotic arm 23 substantially perpendicular to the top surface 26. As the activation head 22 moves across the top surface 26 the separation distance between the nozzles 170 and the top surface 26 is maintained relatively constant whilst the array of nozzles 170 are rotated relative to the direction the activation head 22 is travelling. The nozzles 170 are selectively operable allowing up to four beads 171 to be fabricated simultaneously. This may involve selectively deactivating some of the nozzles 170 to form cavities 172 between solidified beads 170.

FIG. 5B shows the activation head 22 travelling along a path in a first direction 175 across the top surface 26 and operating each nozzle 170 simultaneously, thereby solidifying a corresponding portion 174 of curable material 25. Whilst moving along the path, the array is rotated relative to the first direction, thereby decreasing the width of the solidified portion 174, allowing the portion 174 to be continuously and smoothly varied in width during fabrication. The intensity of exposure of energy by each nozzle 170 may be varied during the fabrication of the portion 174, providing a constant net exposure intensity and therefore solidifying a consistent depth of curable material 174. For example, as the array of nozzles 170 rotates to fabricate a thinner portion, the exposure intensity of all nozzles 170 is decreased. Conversely, when the array of nozzles 170 travels around a curved path (not shown), the nozzle 170 arranged at the outside of the curve exposes at a greater intensity than the nozzle arranged at the inside of the curve. Optionally, the nozzles 170 may be adapted to allow the shape of each nozzle 170 to be adjusted (not shown) and each nozzle 170 to be rotated.

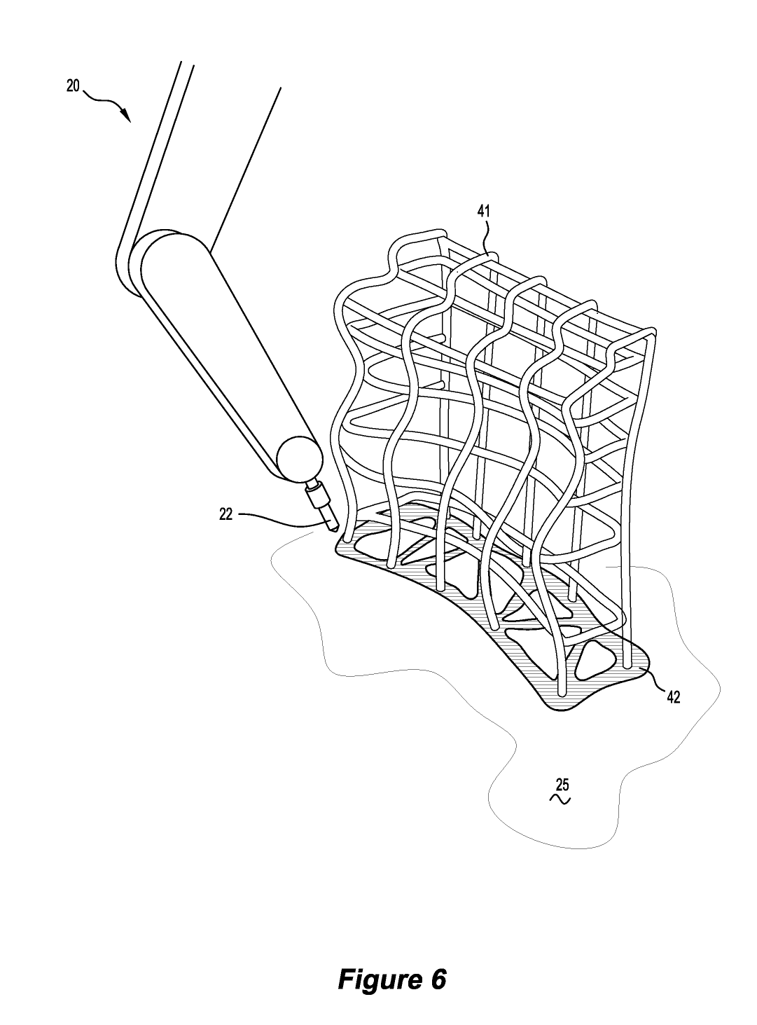

FIG. 6 shows the apparatus 20 fabricating a further alternative object 42 around a reinforcement frame 41. The frame 41 is secured to the platform 27 and the curable material 25 is selectively solidified by the activation head 22 adjacent the frame 41, thereby bonding curable material to the frame 41. Optionally, separate components (not shown) of the reinforcement frame 41 are arranged in the reservoir 24 by the apparatus 20 during the fabrication of the object 42, allowing the activation head 22 to access each component as it is placed in the reservoir 24 and solidify material 25 therearound. Further optionally, the apparatus 20 is adapted to selectively join these components together, such as by welding or mechanically fixing, thereby progressively building the frame 41 during the fabrication process.

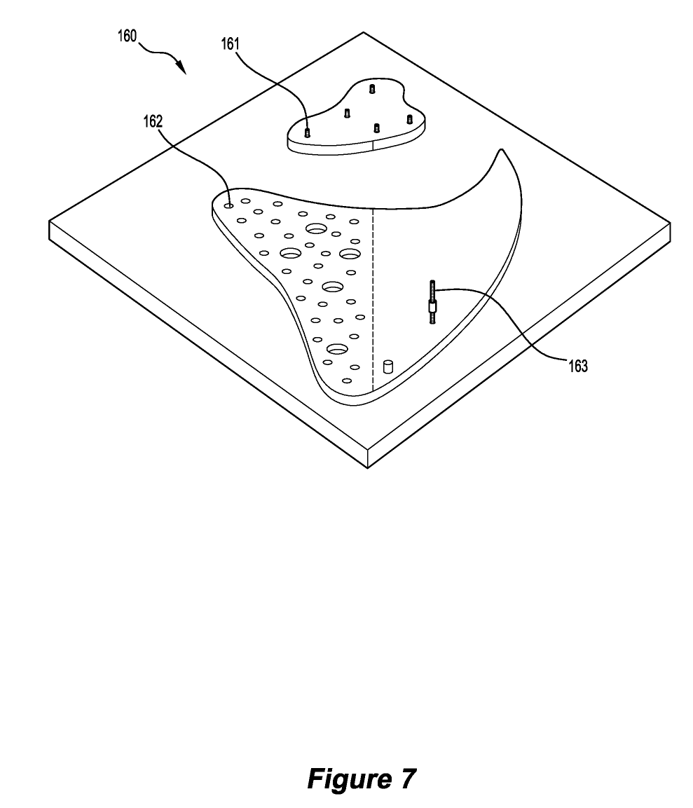

FIG. 7 shows a fixing plate 160 used in conjunction with the apparatus 20. The fixing plate 160 is secured to the platform 27 and provides one or more threaded fixtures 161 and/or textured regions 162 including protrusions and/or recesses, to aid engagement of solidified curable material 25 with the platform 27. The fixing plate 160 may be releasably secured to the platform 27 and permanently affixed to a fabricated object. Additional attachments, such as a threaded bar 163, are securable to the threaded fixtures 161 during the fabrication process, thereby extending the length of the fixing within a fabricated object.

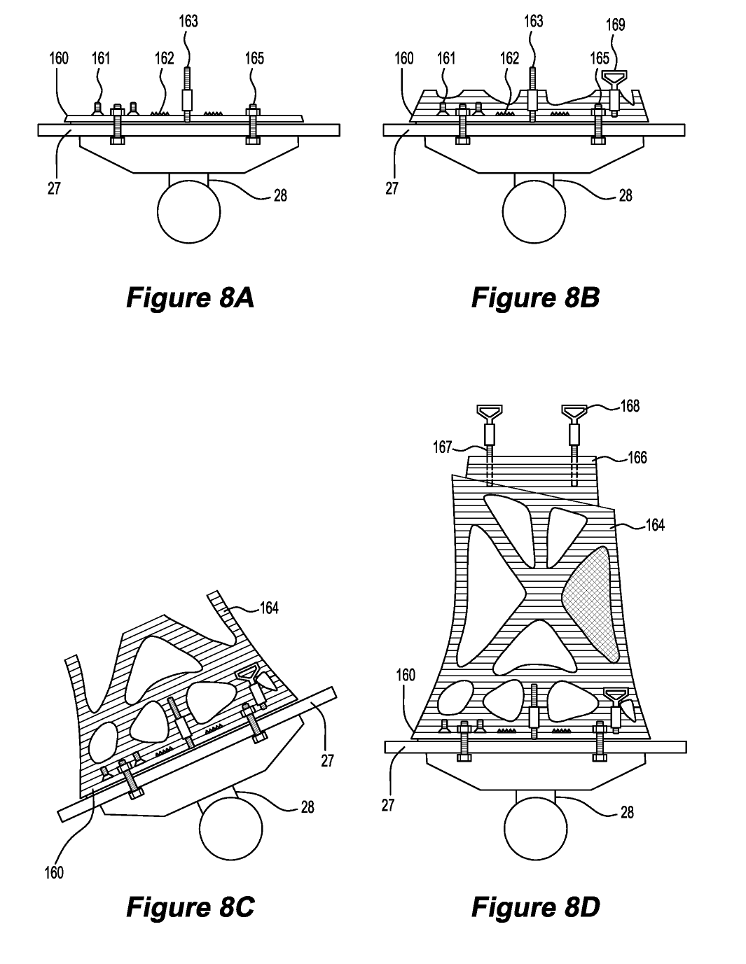

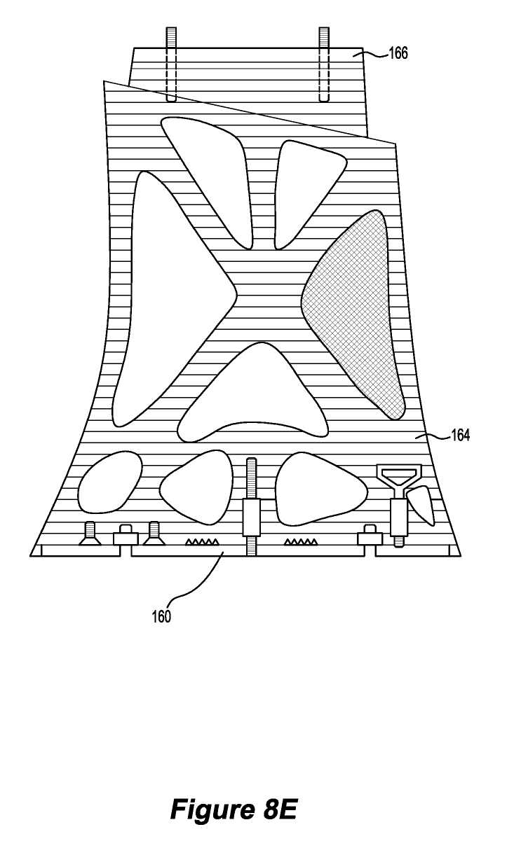

FIGS. 8A to 8E show the fixing plate 160 attached to the platform 27 during various stages of the apparatus 20 fabricating a further alternative object 164. FIG. 8A shows the fixing plate 160 connected to the platform 27 by a plurality of mechanical fasteners 165. FIG. 8B shows a number of layers of the object 164 fabricated in contact with the fixing plate 160, threaded fixtures 161 and perforated region 162. An extender rod 163 and a load spreading fixture 169 are also connected to some of the threaded fixtures 161. FIG. 8C shows a later stage of the fabrication process, where the platform 27 is rotated, thereby tilting the object 164 engaged with the fixing plate 160. FIG. 8D shows the complete object 164 having an additional fixing plate 166 connected to a top surface thereof by two additional threaded fixtures 167. Respective removable lifting fixtures 168 are connected to the threaded fixtures 167. FIG. 8E shows the object 164 removed from the platform 27 with both fixing plates 160, 166 engaged with the object 164.

It will be apparent that obvious variations or modifications may be made to the present invention in accordance with the spirit of the invention and which are intended to be part of the invention. Although the invention is described above with reference to specific embodiments, it will be appreciated that it is not limited to those embodiments and may be embodied in other forms.

1. A method for fabricating an object using a computer-controlled apparatus, the apparatus having a reservoir at least partially filled with a substantially liquid, curable material, an activation head movable relative to the reservoir, and a platform movable relative to the reservoir and rotatable about at least one axis, the method comprising the steps of:
receiving, by the apparatus, computer instructions relating to the object geometry;
moving and selectively operating the activation head, thereby selectively solidifying portions of the curable material in specific locations corresponding with the object geometry, at least some of the solidified portions abutting the platform;
moving the platform, thereby repositioning the solidified portions supported thereon; and
rotating the platform, thereby reorientating the solidified portions supported thereon.

2. The method for fabricating an object according to claim 1, wherein the curable material forms a top surface and wherein the step of moving and selectively operating the activation head further comprises moving and selectively operating the activation head proximal to the top surface to solidify curable material at the top surface.

3. The method for fabricating an object according to claim 1, wherein the step of rotating the platform further comprises rotating the platform about three axes.

4. The method for fabricating an object according to claim 2, wherein the platform further comprises a slidable portion, and the step of moving the platform further comprises sliding the slidable portion substantially parallel to the top surface.

5. The method for fabricating an object according to claim 1, wherein the activation head further comprises an array of activation nozzles rotatable about a second axis, and the step of moving and selectively operating the activation head further comprises arranging the second axis substantially perpendicular to the top surface and rotating the array about the second axis.

6. A method for fabricating an object according to claim 1, wherein at least two of the steps of moving and selectively operating the activation head, moving the platform, and rotating the platform are repeated.

7. The method for fabricating an object according to claim 1, wherein the steps of moving the platform, and rotating the platform, are executed simultaneously.

8. The method for fabricating an object according to claim 1, wherein the apparatus is in communication with a supply of fibres and adapted to selectively deploy the fibres, and before the step of moving and selectively operating the activation head the method comprises the further step of deploying at least one section of the fibres in the reservoir adjacent the activation head.

9. The method for fabricating an object according to claim 1, wherein before the step of moving and selectively operating the activation head the method comprises the further step of securing a reinforcement structure to the platform.

10. A computer-controlled apparatus for fabricating an object, the apparatus comprising:
a reservoir at least partially filled with a substantially liquid, curable material;
an activation head for solidifying the curable material, the activation head being movable relative to the reservoir;
a platform movable relative to the reservoir and rotatable about at least one axis; and
a controller, configured to move the activation head and platform responsive to computer instructions relating to the object geometry;
wherein the controller moves and selectively operates the activation head to solidify portions of the curable material in specific locations corresponding with the object geometry, at least some of the solidified portions abutting the platform; and
the controller moves and rotates the platform, thereby repositioning the solidified portions supported thereon.

11. The computer controlled apparatus for fabricating an object according to claim 10, wherein the platform is rotatable about at least three axes.

12. The computer controlled apparatus for fabricating an object according to claim 10, wherein the controller moves the activation head and platform simultaneously.

13. The computer controlled apparatus for fabricating an object according to claim 12, wherein the controller also rotates the platform simultaneously.

14. The computer controlled apparatus for fabricating an object according to claim 10, wherein the platform has a support surface for supporting the solidified portions.

15. The computer controlled apparatus for fabricating an object according to claim 14, wherein the support surface is at least partially non-planar.

16. The computer controlled apparatus for fabricating an object according to claim 14, wherein the support surface is cylindrical.

17. The computer controlled apparatus for fabricating an object according to claim 10, wherein the activation head further comprises an array of activation nozzles rotatable around a second axis.

18. The computer controlled apparatus for fabricating an object according to claim 10, wherein the apparatus is in communication with a supply of fibres and is adapted to selectively insert the fibres into the reservoir.

19. The computer controlled apparatus for fabricating an object according to claim 10, further comprising a robotic gripper movable relative to the reservoir, and wherein the controller moves and selectively operates the gripper to position objects in the reservoir.

20. The computer controlled apparatus for fabricating an object according to claim 10, further comprising a tool head movable relative to the reservoir, and wherein the controller moves and selectively operates the tool head to position objects in the reservoir.

21. The computer controlled apparatus for fabricating an object according to claim 19, further comprising welding means movable relative to the reservoir, and wherein the controller moves and selectively operates the welding means to weld objects in the reservoir.

22. The computer controlled apparatus for fabricating an object according to claim 10, further comprising a fixing plate adapted to be releasably secured to the platform, the fixing plate having at least one of a threaded fixture and textured region arranged thereon.

23. The computer controlled apparatus for fabricating an object according to claim 20, further comprising welding means movable relative to the reservoir, and wherein the controller moves and selectively operates the welding means to weld objects in the reservoir.
